(19) United States
(12) Patent Application Publication
(10) Pub. No.: US 2008/0174446 A1
(43) Pub. Date: Jul. 24, 2008

(54) MULTI-CHANNEL PASSIVE VEHICLE ACTIVATION SYSTEM

(75) Inventors: Riad Ghabra, Dearborn Heights, MI (US); Ronald O. King, Brownstown, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/868,634

(22) Filed: Oct. 8, 2007

Related U.S. Application Data
(60) Provisional application No. 60/861,838, filed on Nov. 30, 2006.

(51) Int. Cl. H04L 1/00; H04L 1/20

(52) U.S. Cl. 340/825.01

(57) ABSTRACT

Remote activation of an automotive vehicle is improved by determining a frequency for the activation signal based on sampled ambient noise conditions. The selected frequency may be transmitted to a passive remote control device in a challenge signal. The remote control device responds with an activation signal at the selected frequency.

### CROSS-REFERENCE TO RELATED APPLICATIONS

This application claims the benefit of U.S. provisional application Ser. No. 60/861,838 filed Nov. 30, 2006.

### BACKGROUND OF THE INVENTION

The present invention relates in general to passive systems for accessing functionality in passenger vehicles.

Remote vehicle activation systems, such as remote keyless entry (RKE) systems, may be active or passive in nature. In an active system, a switch or pushbutton on a remote transmitter is typically activated by an operator in order to have a desired remote function performed, such as locking or unlocking the vehicle doors. In a passive entry system, no activation by an operator is typically required in order to have a desired remote function performed.

In a typical passive vehicle activation system, a remote transceiver is provided which is commonly referred to as a “fob” or a “card.” Such a fob or card may be attached to a key chain as a separate unit, may be part of the head of an ignition key, or the like. The fob or card automatically transmits a wireless signal, such as a radio frequency (RF) signal, to a vehicle in order to perform any of a variety of remote vehicle functions such as, for example, locking and/or unlocking a vehicle door, enabling and/or disabling the vehicle engine, opening and/or closing vehicle windows, activating internal and/or external vehicle lights, raising and/or lowering convertible tops, opening and/or closing the trunk, and the like.

Passive vehicle activation systems typically include a transceiver in an electronic control module installed in the vehicle. The vehicle transceiver control module is provided in communication with various vehicle devices in order to perform a variety of functions. For example, the vehicle transceiver and/or control module may be provided in communication with a door lock mechanism in order to unlock a vehicle door in response to an unlock request, or may be provided in communication with the vehicle engine in order to start the engine in response to an engine start request.

A sensor or switch may be provided, such as for example in a vehicle door handle, in order to provide the unlock request. In this example, when the vehicle owner makes physical contact with the door handle, such as by grasping or pulling the handle, the sensor provides the vehicle transceiver control module with an indication of such contact. After receiving such an indication, the vehicle transceiver control module automatically transmits a passive entry challenge signal. Upon receipt of the challenge signal, the remote transceiver fob or card, typically carried by the user, determines if the challenge signal is valid and, if so, automatically transmits a response which includes a typically unique identification code of the fob. The vehicle transceiver control module compares the identification code with the codes of authorized fobs and, if a match is found, the control module generates a control signal that, in this example, is transmitted to the door lock mechanism for use in unlocking the vehicle door.

In performing passive vehicle activation functions, it may be helpful to localize (i.e., determine the location of) the user carrying the fob in deciding whether a particular passive entry function should be performed. For example, when the vehicle door handle is activated to generate a door unlock request, the lock should be unlocked if an authorized fob is located outside the vehicle. Otherwise, the vehicle door could be unlocked and opened by anyone outside the vehicle merely because an authorized user is present inside the vehicle. By way of another example, if a user activates a passive engine start switch inside the vehicle, the engine should be started only if an authorized user is present inside the vehicle.

One problem with current passive vehicle activation systems is a susceptibility to interference or noise. For example, other wireless systems may be operating at a frequency that is the same, or close to, either or both of the signal sent from the vehicle to the fob or from the fob to the vehicle (if these signals are transmitted at different frequencies). These wireless systems can include, for example, other fobs or cards, tire pressure monitoring systems, remote security systems, remote garage door openers, and the like.

### SUMMARY OF THE INVENTION

The present invention address the problem of signal interference by using at least one a plurality of multiple frequency channels selected based on sampling ambient conditions.

### BRIEF DESCRIPTION OF THE DRAWINGS

FIG. 1 is a schematic drawing of a vehicle implementing an embodiment of the present invention;

FIG. 2 is a block diagram illustrating a passive entry module according to an embodiment of the present invention;

FIG. 3 is a block diagram illustrating a fob or card according to the present invention;

FIG. 4 is a block diagram illustrating a passive vehicle activation system according to an embodiment of the present invention;

FIG. 5 is a flow diagram illustrating vehicle operation according to an embodiment of the present invention; and

FIG. 6 is a flow diagram illustrating fob operation according to an embodiment of the present invention.

### DETAILED DESCRIPTION OF THE PREFERRED EMBODIMENT(S)

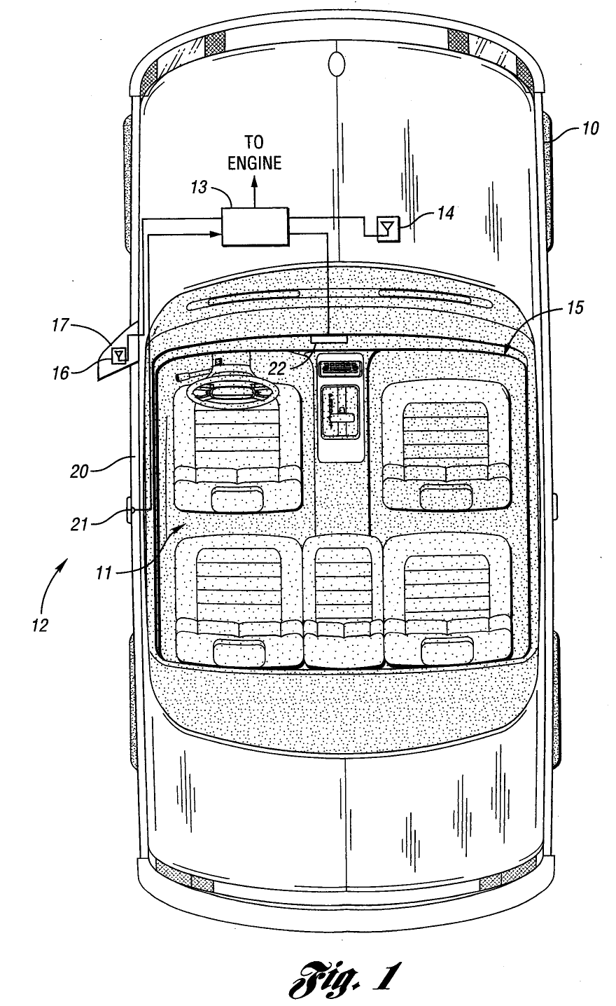

Referring to FIG. 1, a schematic drawing of a vehicle implementing an embodiment of the present invention is shown. Vehicle 10 has an interior region 11 and an exterior region 12. A passive entry electronic module 13 is coupled to an interior antenna 14, which may be mounted to a vehicle instrument panel 15, for example. Module 13 is also coupled with an exterior antenna 16, which may preferably be mounted in an exterior structure such as a side view mirror housing 17 or in a door such as door 20.

Vehicle door 20 may provide a portion of a border between interior region 11 and exterior region 12. A door handle 21 includes an activation switch and a lock actuator mechanism, which are both coupled to module 13. By lifting door handle 21, a user generates a door unlock request that causes module 13 to interrogate for an authorized fob. An engine start switch 22 may also be provided on instrument panel 15 coupled to module 13 in order to generate a user request for starting the vehicle engine. Various other activation functions may be supported such as, for example, locking and/or unlocking other vehicle doors, opening and/or closing vehicle windows, activating internal and/or external vehicle lights, raising and/or lowering convertible tops, opening and/or closing the trunk, and the like.

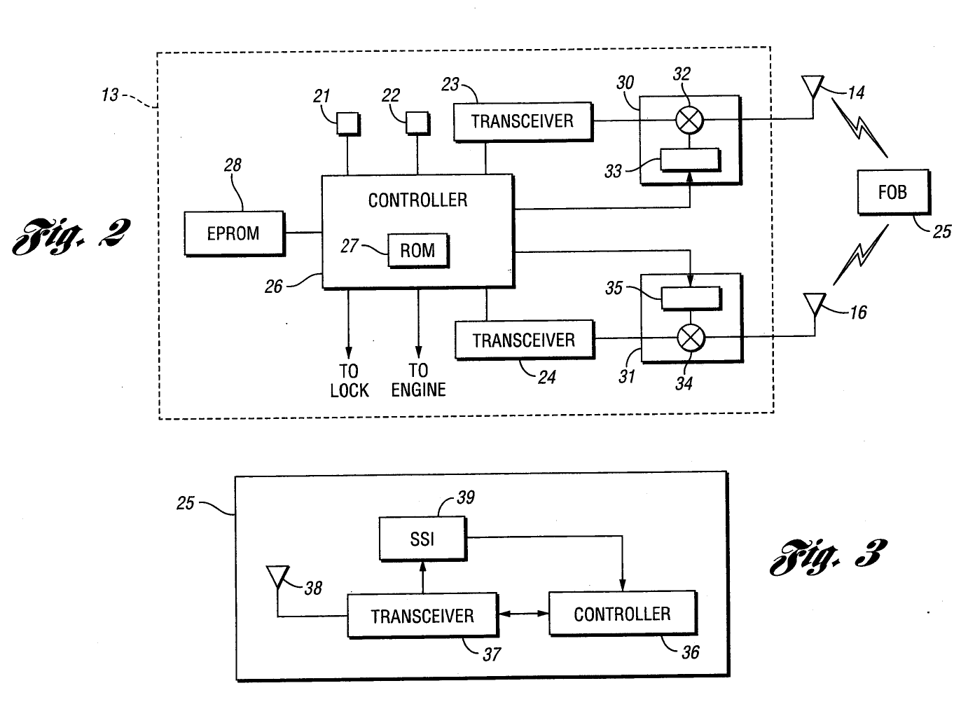

Referring now to FIG. 2, a block diagram illustrating a passive entry module according to an embodiment of the present invention is shown. Passive entry module 13 includes transceiver 23 and transceiver 24. Alternatively, a single transceiver that is switched between internal and external transmission/reception may be used. Passive entry module 13 also includes controller 26 having read-only memory (ROM) 27 which may contain one or more software programs executed by controller 26 as well as data accessed by controller 26. An electrically programmable read-only memory (EPROM) 28 is coupled to controller 26 for storing calibration and other data as is known in the art. EPROM 28 may also hold software executed by controller 26.

Module 13 includes an antenna driver 30 for driving interior antenna 14 and an antenna driver 31 for driving exterior antenna 16. Antennas 14 and 16 provide bi-directional communication with a portable fob or card 25 through transceiver 23 and transceiver 24, respectively. Drivers 30 and 31 may be analog or digitally controlled in response to an interior gain value and an exterior gain value, respectively, from controller 26. The gain values may be stored in EPROM 28, for example. Driver 30 includes a bi-directional variable-gain signal amplifier 32 and a gain block 33 which receives the interior gain value. Likewise, driver 31 may include a bi-directional variable-gain signal amplifier 34 and a gain block 35 which receives the exterior gain value. If the same interior and exterior gain values are used for all passive entry functions, the interior and exterior gain values can be set once during a power-up initialization sequence of module 13. Otherwise, the interior gain values may be transferred to drivers 30 and 31 periodically during operation of the passive entry functions as needed.

Wireless interfaces 23, 24 need not be transceivers connected to internal and external antennas. For example, one or both of wireless devices 23, 24 may be transmit only or receive only devices. Moreover, wireless devices 23, 24 may operate in different frequency ranges or with different types of wireless signals.

Referring now to FIG. 3, a block diagram illustrating a fob or card according to the present invention is shown. Fob 25 includes fob controller 36 coupled by a transceiver 37 to an antenna 38. Alternatively, a separate receiver and transmitter may be utilized to accommodate differences in the frequencies used. Interrogation signals broadcast by the vehicle passive entry module are received by transceiver 37 and detected by controller 36. If the interrogation signals are valid (i.e., correspond to a recognized vehicle and function), controller 36 generates a response message which is broadcast via transceiver 37 and antenna 38 to the vehicle passive entry module. During reception of the interrogation signals, a signal strength indicator (SSI) block 39 may determine received signal strength and generate a signal strength indication. The signal strength indication may be included in the response message assembled by controller 36 according to a predetermined message protocol.

Referring now as well to FIG. 2, fob transceiver 37 and one or more vehicle module wireless devices 23, 24 are operative to transmit and/or receive at a plurality of carrier frequencies. This allows a passive vehicle activation system of the present invention to select a channel with a reduced level of noise. For example, one or more transceiver 23, 24 in vehicle module 13 may periodically sample the environment at frequencies of interest to determine the level of noise. Vehicle module controller 26 may then select one or more of these frequencies for use in communicating with fob 25. Controller 26 may communicate which one or more frequency to use in one or more interrogation signals sent from vehicle module 13 to fob 25.

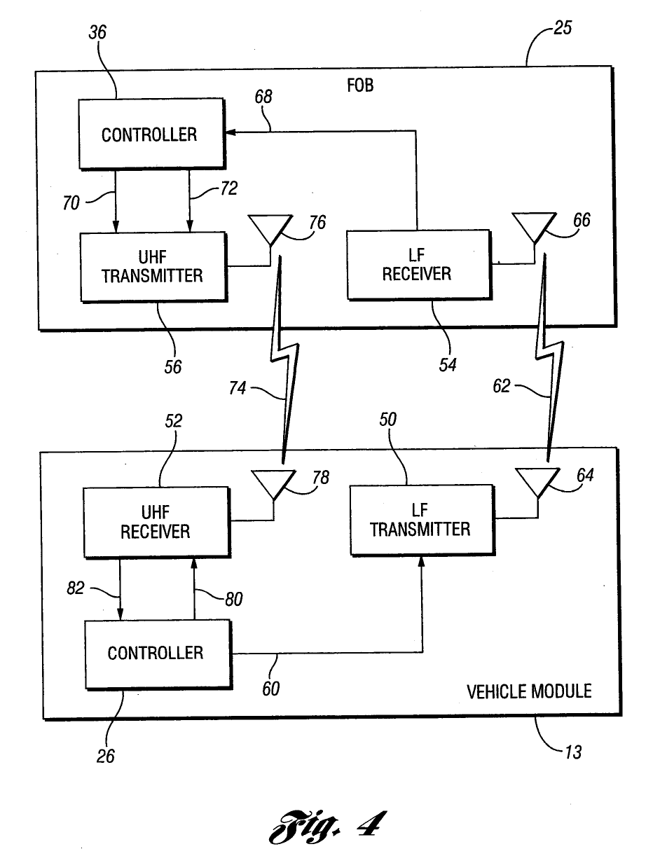

Referring now to FIG. 4, a block diagram illustrating a passive vehicle activation system according to an embodiment of the present invention is shown. Vehicle module 13 includes a low frequency (LF) transmitter 50 and an ultra-high frequency (UHF) receiver 52. Fob 25 includes a LF receiver 54 and a UHF transmitter 56. Alternatively, one or both of UHF transmitter 56 and UHF receiver 52 may be a UHF transceiver.

Vehicle module controller 26 generates control signals 60, including data to be transmitted, for LF transmitter 50. LF transmitter 50 transmits LF signal 62 from LF antenna 64. LF signal 62 is receive by fob LF antenna 66. LF receiver 54 detects or demodulates LF signal 62 to generate received data 68 for fob controller 36.

Fob controller 36 is operative to generate frequency control signals 70 and transmission control signals 72 including data to be transmitted by UHF transmitter 56. UHF transmitter 56 transmits UHF signal 74 from fob UHF antenna 76. UHF signal 74 is received by vehicle module UHF antenna 78. UHF receiver 52 detects or demodulates UHF signal 74 to generate data 80 for vehicle module controller 26. UHF receiver 52 also receives frequency control signals 82 for setting a center frequency or otherwise selecting a channel or channels for receiving UHF signals from antenna 78. UHF receiver 52 also includes the ability to determine received signal strength such as, for example, by generating a received signal strength indication (RSSI) signal as data 80 provided to vehicle module controller 26.

When an activation function is requested, a challenge is issued to fob 25 in the form of a LF signal 62. Fob 25 then responds by transmitting a UHF signal 74. In order to make the system more immune to jamming and noise from other sources, the UHF channel of operation may be changed as needed. The vehicle module will determine which one or more channel is clear (free of noise) or clearer or clearest by periodically checking the RSSI levels from UHF receiver 52. Controller 26 will select one or more channels based on the ambient noise levels. This selection may be the most quiet channel. Alternatively, this selection may be a channel or channels having a noise level below a threshold. This selection may be based on searching channels in a particular preferred order until an appropriate channel or channels are found. This order may be based on vehicle location or on information known about the vehicle. Once the channel or channels are selected, fob 25 is informed of the selection during the LF challenge phase. When fob 25 wakes up on LF challenge, it decodes LF signal 62 and switches to the clear channel or channels indicated by the vehicle module 13. Thus, the probability that the vehicle will receive the UHF response from fob 25 is improved.

The present invention provides a feasible, fast, and power-efficient way to switch channels. In order to save on power draw from the vehicle battery, vehicle module controller 26 may instruct UHF receiver 52 to check for a clear channel or channels at periodic intervals.

UHF receiver 52 and UHF transmitter 56 may be implemented with any of a wide variety of circuits as is known in the art. For example, transmitter 56 may be implemented using the ADF7012 Multichannel ISM Band FSK/GFSK/OOK/ASK Transmitter from Analog Devices of Norwood, Mass. This transmitter includes a fractional-N phase locked loop (PLL) which may be loaded with a data value to set an operating frequency between 75 MHz and 1 GHz.

Alternatively, or in addition to the above embodiments, a multi-channel LF receiver in the fob may be used to avoid LF noise sources. Moreover, the present system may also be used with LF/RF/RF challenge response systems as well as LF/RF systems.

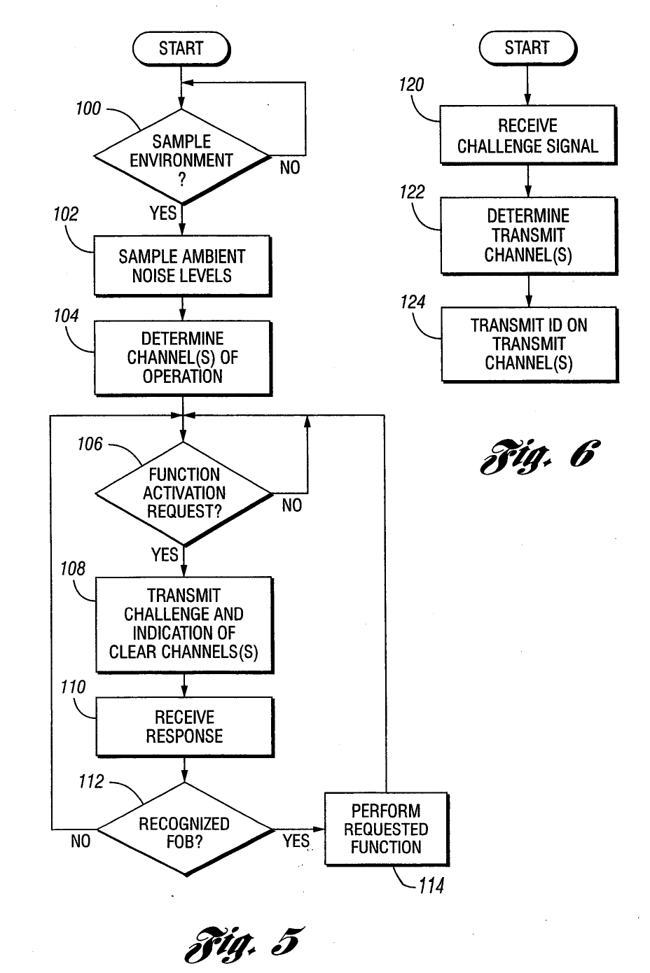

Referring now to FIGS. 5 and 6, flow diagrams illustrating methods of operating according to embodiments of the present invention are shown. As will be appreciated by one of ordinary skill in the art, the operations illustrated are not necessarily sequential operations. The order of steps may be modified within the spirit and scope of the present invention and the order shown here is for logical presentation. Also, methods illustrated may be implemented by any combination of hardware, software, firmware, and the like, at one location or distributed. The present invention transcends any particular implementation and the embodiments are shown in sequential flow chart form for ease of illustration.

Referring now to FIG. 5, a flow diagram illustrating vehicle operation according to an embodiment of the present invention is shown. A check is made to determine if the ambient environment should be sampled for noise, as in block 100. This check may be made on a periodic basis. Alternatively, or in addition to a periodic check, a check may be made following detection of a certain event, such as a request for a particular function. The ambient noise level in one or more channels is then sampled, as in block 102. A determination is then made as to which one or more channels will be used, as in block 104, based on the noise levels measured. The last successful channel may be used unless there is a need to change channels. This need may be based on sampling the noise level of this channel, a received control signal, a received signal from the fob, or the like.

Eventually, a request for an activation function is received, as in block 106. At least one challenge is transmitted from the vehicle, as in block 108. Information specifying the channel or channels to be used in responding to the channel is preferably provided in the challenge. A response is received in one or more of the specified challenges, as in block 110. This response preferably includes a fob identifier or other data indicating authorized use of the desired function. A check is made to determine if the identifier or other data is correct, as in block 112. This may be done, for example, by checking a received identifier against a list of authorized identifiers. If the received data indicates authorized use of the function, the function is performed, as in block 114.

In one embodiment of the present invention, a plurality of challenges may be transmitted from the vehicle, as in block 108. For example, if a challenge has not been responded to within a certain period of time, the challenge may be retransmitted. Moreover, at least one of the retransmissions may be made using one or more different characteristics from the first transmission such as, for example, carrier frequency, modulation technique, encoding scheme, channel selection, identifier, and the like.

Referring now to FIG. 6, a flow diagram illustrating fob operation according to an embodiment of the present invention is shown. A challenge signal is received, as in block 120. This challenge signal may be used to wake up electronics in the fob. A determination is made as to which one or more channels should be used for transmitting, as in block 122. This determination may be based on information received in the challenge signal. The fob transmits a response, as in block 124. This response may include a transmitter identifier or other information which may be used by the vehicle to determine if a requested function is allowed.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A passive activation system for use in an automotive vehicle comprising:
a fob operative to receive a challenge signal and to send an activation signal in response to the challenge signal at one of a plurality of frequencies; and
an activator installed in the automotive vehicle, the activator operative to select one of the plurality of frequencies based on transmission quality, transmit an indication of the selected frequency to the fob, transmit the challenge signal, and receive the activation signal at the selected frequency.

2. The passive activation system of claim 1 wherein the activator selects one of the plurality of frequencies by sampling ambient noise at each of the plurality of frequencies.

3. The passive activation system of claim 2 wherein the activator uses the selected frequency for subsequent reception of the activation signal unless ambient noise at the selected frequency exceeds a threshold.

4. The passive activation system of claim 1 wherein the fob comprises a LF receiver and a UHF transmitter and wherein the activator comprises a LF transmitter and a UHF receiver.

5. The passive activation system of claim 4 wherein the activator transmits the challenge signal using the LF transmitter, the fob receives the challenge signal using the LF receiver, the fob transmits the activation signal using the UHF transmitter, and the activator receiving the activation signal using the UHF receiver.

6. The passive activation system of claim 1 wherein the activator transmits the indication of the selected frequency in the challenge signal.

7. The passive activation system of claim 1 wherein the activator is further operative to activate a vehicle function if the received activation signal includes an identifier for a previously recognized fob.

8. The passive activation system of claim 1 wherein the transmitted challenge is a first challenge, the activator further operative to determine that no activation signal was received in response to the first challenge and to transmit at least one additional challenge having at least one characteristic different from the first challenge.

9. A method of remotely activating a function in an automotive vehicle, the method comprising:
transmitting a first signal from the automotive vehicle indicating one of a plurality of channels based on ambient noise detected in at least one of the plurality of channels;
receiving the first signal in a remote device operative to be moved separately from the automotive vehicle;
setting a transmitter in the remote device to transmit at the indicated channel based on the received first signal;
transmitting from the remote device a second signal using the indicated channel;
receiving the second signal at the automotive vehicle; and
activating the automotive vehicle function based on the received second signal.

10. The method of claim 9 wherein the first signal is transmitted at a first frequency and the second signal is transmitted at a second frequency different than the first frequency.

11. The method of claim 10 wherein the first frequency is in the LF band and the second frequency is in the UHF band.

12. The method of claim 9 wherein the first signal is a challenge signal transmitted from the automotive vehicle in response to a request for the function.

13. The method of claim 9 wherein the second signal comprises a remote device identifier and wherein activating the function is based on the remote device identifier matching a known identifier.

14. The method of claim 9 wherein the remote device continues to transmit signals using the indicated channel until receiving a signal instructing the remote device to use a different one of the plurality of channels.

15. An automotive vehicle comprising:
a transmitter;
a receiver;
automotive equipment operated by a control signal; and
control logic in communication with the transmitter, the receiver, and the automotive equipment, the control logic operative to
(a) sample noise in the environment using the receiver;
(b) determine a channel of operation from a plurality of possible channels based on the sampled noise;
(c) transmit a channel signal indicating the determined channel using the transmitter;
(d) receive an activation signal from the receiver using the determined channel; and
(e) generate the control signal based on the received activation signal.

16. The automotive vehicle of claim 15 wherein the transmitter operates in a LF band and wherein the plurality of channels operate at different frequencies in the UHF band.

17. The automotive vehicle of claim 15 wherein the channel signal is part of a challenge signal transmitted to a remote device.
